(19) United States
(12) Patent Application Publication
(10) Pub. No.: US 2005/0207772 A1
(43) Pub. Date: Sep. 22, 2005

(54) Fixing apparatus and image forming apparatus

(75) Inventor: Sunao Takenaka, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/800,632

(22) Filed: Mar. 16, 2004

(51) Int. Cl. G03G 15/20

(52) U.S. Cl. 399/69

(57) ABSTRACT

A temperature T of the heating roller 2 is detected by a thermistor 10 and an amount of variation (ΔT/AΔ) per unit time t of the detected temperature T is detected. The output of a coil 4 is increased or decreased by an amount corresponding to an amount of detected temperature variation (ΔT/Δt), while the temperature T detected by the thermistor 10 is kept within an initially set range “Tb≧T>Tc”.

### BACKGROUND OF THE INVENTION

1. Field of the Invention

The present invention relates to a fixing apparatus mounted in an image forming apparatus, such as a copying machine and printer, and configured to fix a developing agent image to a paper sheet.

2. Description of the Related Art

As a heating source for a fixing apparatus for use in an electrophotographic system, a source using an induction heating system has been put to practical use. In the induction heating, a high frequency current is flowed in a coil for induction heating to generate a high frequency magnetic field from the coil and, under the high frequency magnetic field, an eddy current is generated in a heating roller of a heating body, so that the heating roller generates heat due to joule heat caused by the eddy current.

In the fixing apparatus utilizing such induction heating, the temperature of the heating roller is detected by a temperature sensor such as a thermistor. The output of the coil is switched ON or OFF in accordance with the detected temperature of the temperature sensor and the heating roller is kept to a temperature necessary for fixing.

However, with the ON/OFF switching of the coil, the temperature of the heating roller varies, resulting in poor stability, which is a problem.

Further, along with the ON/OFF switching of the coil, there occurs a variation in an input voltage from a power supply to the fixing apparatus. In this case, there sometimes occurs a “flicker” in the light of other apparatuses, such as lighting fixtures which are used under the same power supply.

### BRIEF SUMMARY OF THE INVENTION

The present invention has been conceived with the above-mentioned situation taken into consideration and the object of the present invention is to provide a fixing apparatus and an image forming apparatus which can stably maintain the temperature of the heating roller to a temperature necessary for fixing and eliminate a variation in an input voltage to the apparatuses above.

The fixing apparatus of the present invention comprises a heating roller; a coil configured to apply a magnetic field for induction heating to the heating roller; a temperature sensor configured to detect the temperature of the heating roller; a detection section configured to detect an amount of variation per unit time of a temperature detected by the temperature sensor; and an output control section configured to, while holding the detected temperature of the temperature sensor within an initially set range, to allow the output of the coil to be increased or decreased by an amount corresponding to a detected result of the detection section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing an inner arrangement of one embodiment;

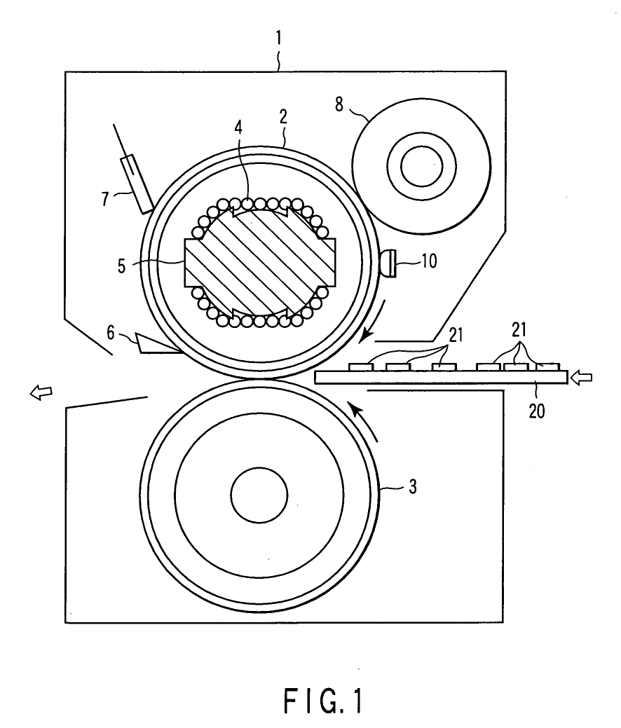

FIG. 2 is a block diagram showing a control circuit of an electrophotographic copying machine according to the one embodiment;

FIG. 3 is a block diagram of an electrical circuit of the one embodiment;

FIG. 4 is view showing a relation among the temperature of a heating coil, an output of a coil and an input voltage in the one embodiment;

FIG. 5 is a flow chart for explaining the function of the one embodiment;

FIG. 6 is a flow chart continued from FIG. 5; and

FIG. 7 is a flow chart continued from FIGS. 5 and 6.

### DETAILED DESCRIPTION OF THE INVENTION

With reference to the drawing, an explanation will be made below about one embodiment of the present invention.

A fixing apparatus 1 has a heating roller (heating member) 2 and a pressure application roller (pressure applying member) 3 configured to be rotated with the heating roller 2 in a manner to be set in pressure contact with the heating roller 2 to allow a to-be-fixed paper sheet 20 to be conveyed while sandwiching the paper sheet 20 with these rollers 2, 3.

The heating roller 2 is cylindrically formed by a conductive member, such as iron, coated around an outer peripheral iron surface with Tefron, etc., and is rotation driven in a right direction shown. The pressure application roller 3 is rotated in a left direction shown under the rotation of the heating roller 2. The paper sheet 20 passes through a contacting portion between the heating roller 2 and the pressure application roller 3 and, under the application of heat from the heating roller 2, and a developing agent image 21 on the paper sheet 20 is fixed onto the paper sheet 20.

A coil 4 for induction heating is held in an inner space of the heating roller 2. The coil 4 is wound around, and held by, the core 5 and generates a high frequency magnetic field for induction heating. Under the generation of the high frequency magnetic field, an eddy current is generated in the heating roller 2 and, due to a joule heat resulting from the eddy current, there occurs a self heat generation of the heating roller 2.

Around the circumference of the heating roller 2 are arranged a separation claw 6 for separating the paper sheet 20 from the heating roller 2, a cleaning member 7 for removing a residual toner, paper dust, etc., left on the heating roller 2, a coating roller 8 for coating a mold releasing agent on the surface of the heating roller 2, and a temperature sensor, such as a thermistor 10, for detecting a temperature T of the heating roller 2.

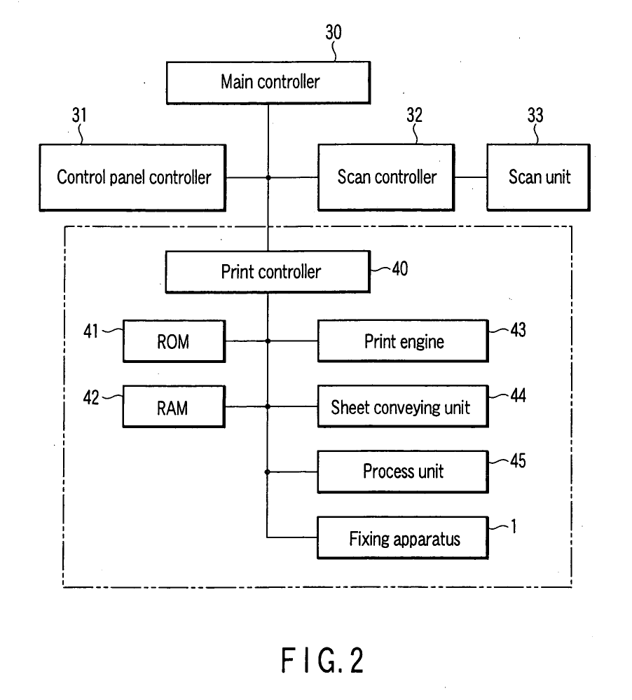

FIG. 2 shows a control circuit of an image forming apparatus relating to the present invention.

To a main controller 30 are connected a control panel controller 31, scan controller 32 and a print controller 40. The main controller 30 generally controls the control panel controller 31, scan controller 32 and print controller 40.

A scan unit 33 for reading out a document is connected to the scan controller 32. To the print controller 40 are connected a ROM 41 for control program memory, a RAM 42 for data memory, a print engine 43, a paper sheet conveying unit 44, a process unit 45, and the above-mentioned fixing apparatus 1. The print engine 43 comprises the above-mentioned laser light driving system, etc. The paper sheet conveying unit 44 comprises a paper sheet P conveying mechanism and its driving circuit, etc. The process unit 45 comprises a photosensitive drum and its peripheral section, etc.

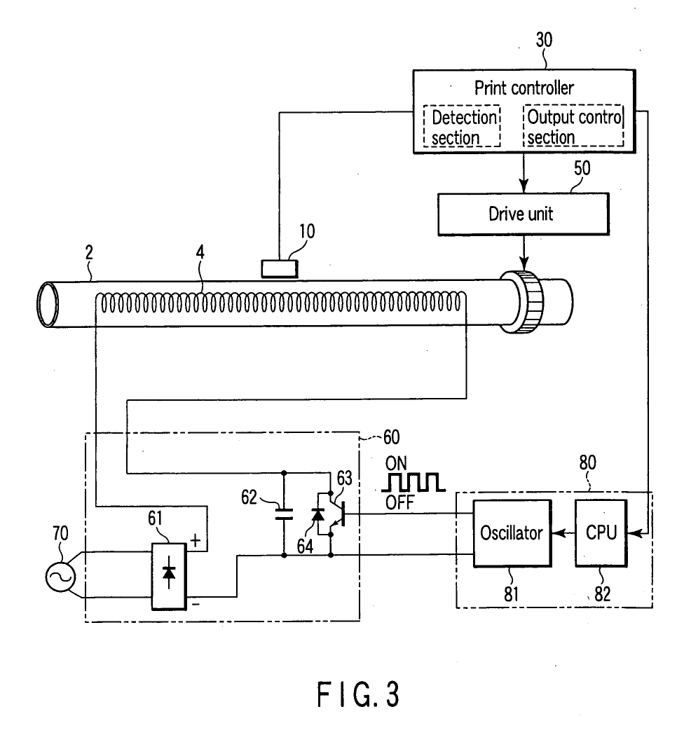

FIG. 3 shows an electrical circuit of the fixing apparatus 1.

To the above-mentioned print controller 40 are connected the above-mentioned thermistor 10, drive unit 50 and controller 80. The drive unit 50 rotationally drives the heating roller 12.

The print controller 40 controls the drive unit 50 and, in accordance with the detected temperature T of the temperature sensor 10, controls the driving of a later-described resonance circuit including the coil 4 as a constituent element.

A high-frequency generating circuit 60 is connected to the coil 4 in the heating roller 2. The high-frequency wave generating circuit 60 is configured to generate high frequency power for generating a high frequency magnetic field and comprises a rectifier circuit 61 for rectifying an AC voltage of a commercial alternating current supply 70, a capacitor 62 connected to an output terminal of the rectifier circuit 61 and, together with the coil 4, constituting the resonance circuit, a switching element, such as a transistor (FET) 63, connected in parallel with the capacitor 62 and configured to excite the above-mentioned resonance circuit, and a damper diode 64 connected to the transistor 63 and used for preventing a back electromotive force.

An oscillator 81 of the above-mentioned controller 80 is connected between the base and the emitter of the transistor 63. The oscillator 81 delivers an ON-OFF signal for ON-OFF driving the transistor 61. The frequency of the ON-OFF signal is the same as the resonance frequency of the resonance circuit.

The controller 80 has, in addition to the oscillator 81, a CPU 82. The CPU 82 controls a duty D of the ON-OFF signal from the oscillator 81 in accordance with an instruction from the print controller 40. Hereinbelow, the duty D of the ON/OFF signal is referred to as the ON-OFF duty D of the transistor 63.

Further the print controller 40 has a detection section and an output control section.

The detection section detects an amount of variation (ΔT/Δt) per unit time t of the temperature T detected by the thermistor 10. The unit time t is a value proportional to the magnitude of the heat capacity of the heating roller 2 and is set within a range of, for example, 1 or 2 seconds. The heat capacity of the heating roller 2 corresponds to the thickness of a cylindrical conductive material (for example, iron) formed as the heating roller 2.

At a ready time and printing time of an image forming apparatus, the output control section allows an output of the coil 4 to be increased or decreased by an amount corresponding to a temperature variation amount (ΔT/Δt) detected by the above-mentioned detection section, while holding the detected temperature T of the thermistor 10 within an initially set range.

This function will be explained below.

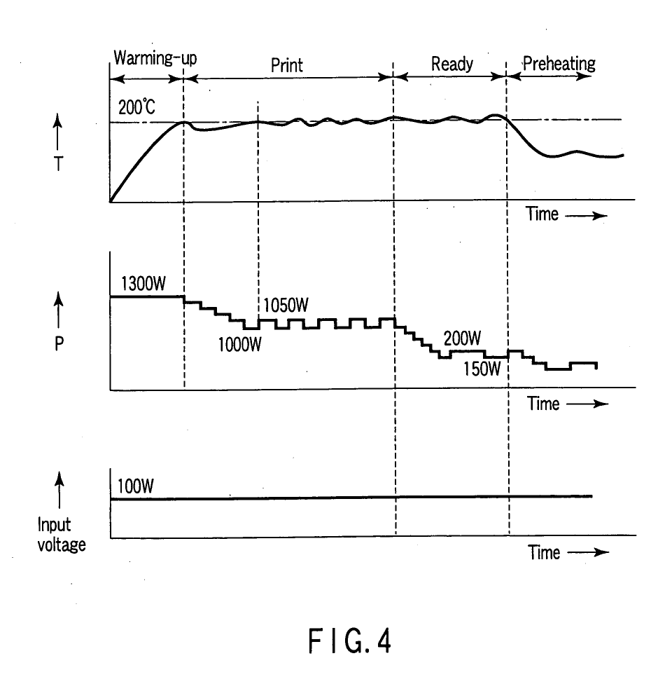

At a warming-up time of the image forming apparatus, the ON-OFF duty D of the transistor 63 is set to be greater. By doing so, as shown in FIG. 4, the output P of the coil 4 is set to 1300 W at max and the temperature T of the heating roller 2 rises quickly.

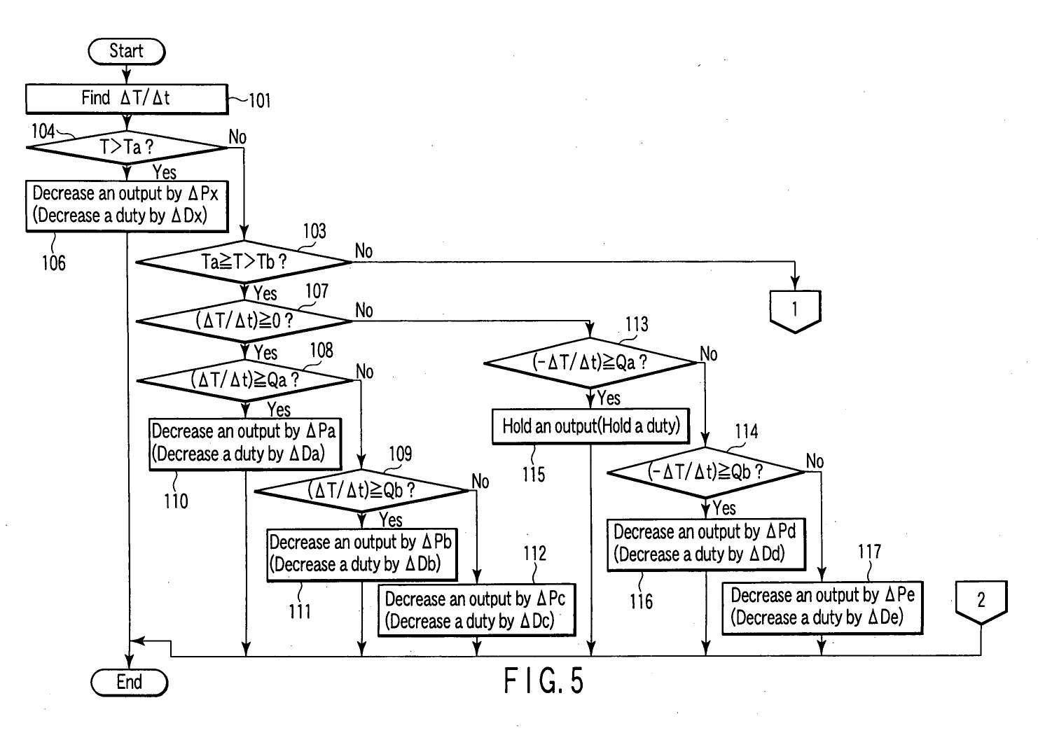

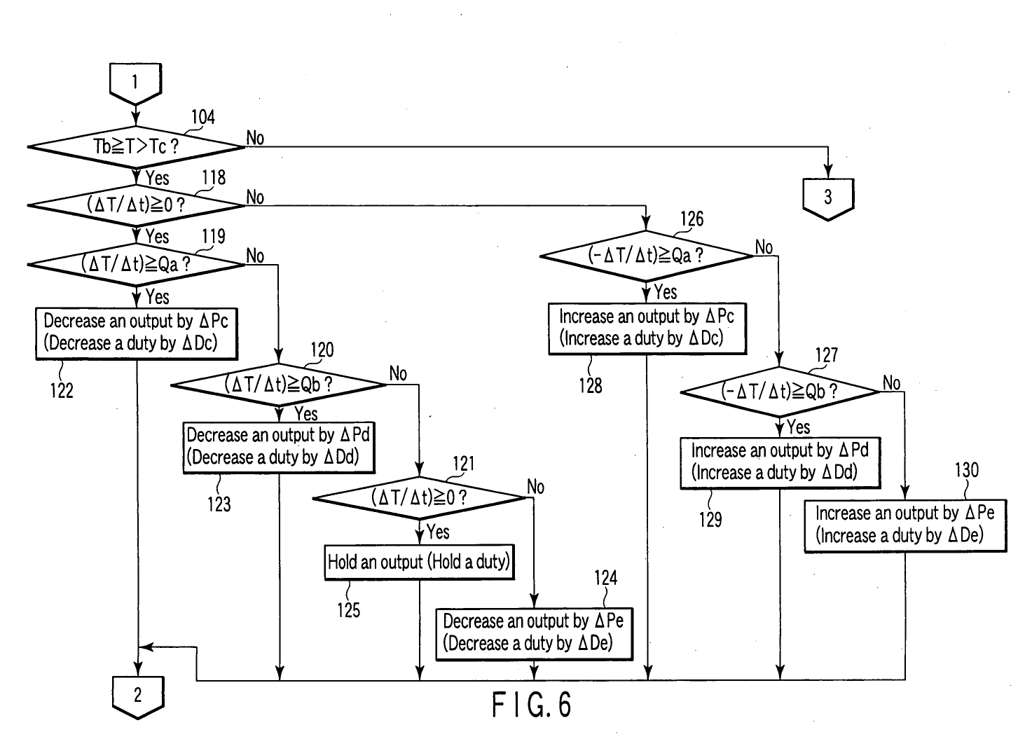

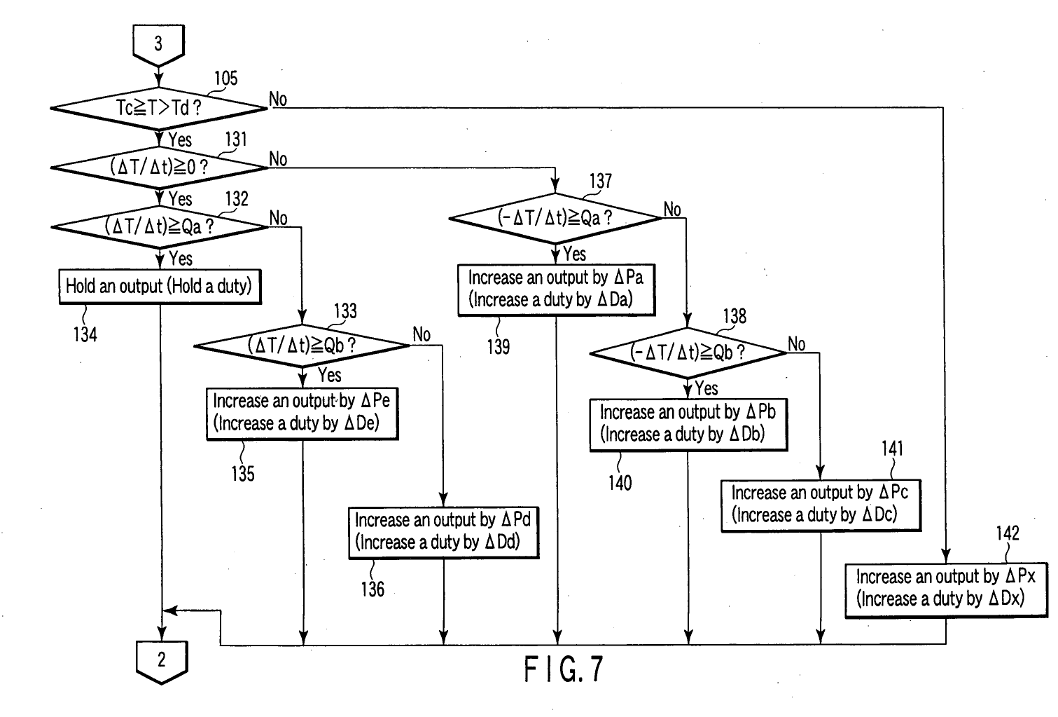

When the temperature T of the heating roller 2 is detected and the detected temperature T reaches a set value, for example, 200° C., the warming-up is ended and control as shown in FIGS. 5, 6 and 7 is preformed.

First, the variation (ΔT/Δt) per unit time t of the temperature T detected by the thermistor 10 is detected (step 101). Comparison is the made between the detected temperature T of the thermistor 10 and the initially set values Ta, Tb, Tc, Td (steps 102, 103, 104, 105). A relation Ta>Tb>Tc>Td exists among the set values Ta, Tb, Tc, Td.

(1) With the detected temperature T high and under the condition “T>Ta” (YES at step 102), the ON-OFF duty D of the transistor 63 is decreased by ΔDx. By doing so, the output P of the coil 4 is decreased by ΔPx (at step 106). By this output decrease, the temperature of the heating roller 2 varies downwards.

(2) Under the condition “Ta≧T>Tb” of the detected temperature T (YES at step 103), it is decided whether or not the amount of variation of detected temperature (ΔT/Δt) as set out above satisfies the condition “(ΔT/Δt)≧0” (step 107).

If the condition “(ΔT/Δt)≧0” is satisfied (YES at step 107), that is, the amount of temperature variation (ΔT/Δt) is an “upward variation” or “0”, comparison is made between the amount of temperature variation (ΔT/Δt) and the initially set values Qa, Qb, (steps 108, 109). The set values Qa, Qb, have a relation Qa>Qb.

Under the condition “(ΔT/Δt)>Qa” (YES at step 108), the ON-OFF duty D of the transistor 63 is decreased by ΔDa (<ΔDx). By doing so, the output P of the coil 4 is decreased by ΔPa (<ΔPx)—step 110.

Under the condition “(ΔT/Δt)>Qb” (YES at step 109), the ON/OFF duty D of the transistor 63 is decreased by ΔDb (<ΔDa). By doing so, the output P of the coil 4 is decreased by ΔPb (<ΔPa)—step 111.

Under the condition “(ΔT/Δt)≦Qb” (NO at step 109), the ON-OFF duty D of the transistor 63 is decreased by ΔDc (<ΔDb). By doing so, the output P of the coil 4 is decreased by ΔPc (<ΔPc)—step 112.

By the processing at steps 108, 109, 110, 111, 112, the temperature T of the heating roller 2 is adjusted downwards.

If, on the other hand, the condition “(ΔT/Δt)≧0” is not satisfied (NO at step 107), that is, the amount of temperature variation (ΔT/Δt) is a “downward variation”, comparison is made between the amount of temperature variation (−ΔT/Δt) and the set vales Qa, Qb—steps 113, 114.

Under the condition “(−ΔT/Δt)>Qa”—YES of step 113, the ON-OFF duty D at this time of the transistor 63 is held as it is. By doing so, the output P of the coil 4 is held (step 115).

Under the condition “(−ΔT/Δt)>Qb”—YES at step 114, the ON-OFF duty D of the transistor 63 is decreased by the ΔDd (ΔDc). By doing so, the output P of the coil 4 is decreased by ΔPd (<ΔPc)—step 116.

Under the condition “(−ΔT/Δt)≦Qb”—NO at step 114, the ON-OFF duty D of the transistor 63 is decreased by ΔDe (<ΔDa). By doing so, the output P of the coil 4 is decreased by ΔPe (<ΔPa)—step 117.

Also by the processing at steps 113, 114, 115, 116, 117, the temperature T of the heating roller 2 is adjusted downwards.

(3) Under the condition “Tb≧T>Tc” (YES at step 104) of the detected temperature T, it is decided whether or no the above-mentioned amount of detected temperature variation (ΔT/Δt) satisfies the condition “(ΔT/Δt)≧0”—step 118.

If the condition “(ΔT/Δt)≧0” is satisfied (YES at step 118), that is, the amount of temperature variation (ΔT/Δt) varies upwards or “0”, comparison is made between the amount of temperature variation (ΔT/Δt) and the set values Qa, Qb—steps 119 and 120.

Under the condition “(ΔT/Δt)>Qa”—YES at step 119, the ON-OFF duty D of the transistor 63 is decreased by ΔDc. By doing so, the output P of the coil 4 is decreased by ΔPc—step 122.

Under the condition “(ΔT/Δt)>Qb”—YES at step 120, the ON-OFF duty D of the transistor 63 is decreased by ΔDd. By doing so, the output P of the coil 4 is decreased by ΔPd—step 123.

Under the condition “(ΔT/Δt)≦Qb”—NO at step 120 and NO at step 121, the ON/OFF duty D of the transistor 63 is decreased by ΔDe. By doing so, the output P of the coil 4 is decreased by ΔPe—step 124.

It is to be noted that, under the condition “(ΔT/Δt)=0”—YES at step 121, the ON-OFF duty D of the transistor 63 at this time is held at it is. By doing so, the output P of the coil 4 is held—step 125.

By the processing at steps 119, 120, 121, 122, 123, 124, 125, the temperature T of the heating roller 2 is adjusted downwards.

If, on the other hand, the condition “(ΔT/Δt)≧0” is not satisfied (NO at step 118), that is, the amount of temperature variation (ΔT/Δt) “varies downwards”, comparison is made between the amount of this temperature variation (−ΔT/Δt) and the set values Qa, Qb—steps 126, 127.

Under the condition “(−ΔT/Δt)>Qa”—YES at step 126, the ON-OFF duty D of the transistor 63 is increased by ΔDc. By doing so, the output P of the coil 4 is increased by ΔPc—step 128.

Under the condition “(−ΔT/Δt)>Qb”—YES at step 127, the ON-OFF duty D of the transistor 63 is increased by ΔDa. By doing so, the output P of the coil 4 is increased by ΔPd—step 129.

Under the condition “(−ΔT/Δt)≦Qb”—NO at step 127, the ON-OFF duty D of the transistor 63 is increased by ΔDe. By doing so, the output P of the coil 4 is increased by ΔPE—step 130.

By the processing at steps 126, 127, 128, 129, 130, the temperature T of the heating roller 2 at this time is adjusted upwards.

(4) Under the condition “Tc≧T>Td” of the detected temperature T—YES at step 105, it is decided whether or not the amount of detected temperature variation (ΔT/Δt) satisfies the condition “(ΔT/Δt)≧0”—step 131.

If the condition “(ΔT/Δt)≧0” is satisfied—YES at step 131, that is, the amount of temperature variation (ΔT/Δt) “is upwards or “0”, comparison is made between the amount of temperature variation (ΔT/Δt) and the set values Qa, Qb—steps 132, 133.

Under the condition “(ΔT/Δt)>Qa”—YES at step 132, the ON-OFF duty D of the transistor 63 at this time is held as it is. By doing so, the output P of the coil 4 is held—step 134.

Under the condition “(ΔT/Δt)>Qb”—YES at step 133, the ON-OFF duty D of the transistor 63 is increased by ΔDe. By doing so, the output P of the coil 4 is increased by ΔPe—step 135.

Under the condition “(ΔT/Δt≦Qb)”—NO at step 133, the ON/OFF duty D of the transistor 63 is increased by ΔDd. By doing so, the output P of the coil 4 is increased by ΔPd—step 136.

By the processing at steps 132, 133, 134, 135, 136, the temperature T of the heating roller 2 is adjusted upwards.

If, on the other hand, the condition “(ΔT/Δt)≧0” is not satisfied—NO at step 131, that is, the amount of temperature variation (ΔT/Δt) is “a downward variation”, comparison is made between the amount of this temperature variation (−ΔT/Δt) and the set values Qa, Qb—steps 137, 138.

Under the condition “(−ΔT/Δt)>Qa”—YES at step 137, the ON-OFF duty D of the transistor 63 is increased by ΔDa. By doing so, the output P of the coil 4 is increased by ΔPa—step 139.

Under the condition “(−ΔT/Δt)>Qb”—YES at step 138, the ON-OFF duty D of the transistor 63 is increased by ΔDb. By doing so, the output P of the coil 4 is increased by ΔPb—step 140.

Under the condition “(−ΔT/Δt)≦Qb”—NO at step 138, the ON/OFF duty D of the transistor 63 is increased by ΔDc. By doing so, the output P of the coil 4 is increased by ΔPc—step 141.

Also by the processing at steps 137, 138, 139, 140, 141, the temperature T of the heating roller 2 is adjusted upwards.

(5) With the detected temperature T low and under the condition “Td≧T”—NO at step 105, the ON-OFF duty D of the transistor 63 is increased by ΔDx. By doing so, the output P of the coil 4 is increased by ΔPx—step 142. By this increase of the output, the temperature of the heating roller 2 varies upwards.

As set out above, the temperature T of the heating roller 2 is detected by the thermistor 10 and an amount of variation (ΔT/Δt) per unit time t of the detected temperature T is detected. The output of the coil 4 is thus increased or decreased by an amount corresponding to the amount of detected temperature variation (ΔT/Δt) while holding the detected temperature T of the thermistor 10 within the initially set range “Tb≧T>Tc”.

As shown in FIG. 4, it is possible to stably maintain the temperature T of the heating roller 2 to a temperature necessary for fixing and to improve reliability relating to the fixing.

Further, since it is possible to eliminate a variation of an input voltage from a commercial AC supply 70 to the corresponding apparatus, there occurs no flicker in other apparatuses, such as the lighting fixtures, using the same commercial AC supply 70.

It is to be noted that, although the heating roller 2 is used as a heating member, an endless belt including a conductor as a heating element may be used in place of the heating roller 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A fixing apparatus comprising:
a heating member;
a coil configured to apply a magnetic field for induction heating to the heating member;
a temperature sensor configured to detect the temperature of the heating member;
a detection section configured to detect an amount of variation per unit time of the temperature detected by the temperature sensor; and
an output control section configured increase or decrease the output of the coil by an amount corresponding to a result of detection by the detection section, while holding the detected temperature of the temperature sensor within an initially set range.

2. A fixing apparatus according to claim 1, wherein said unit time is a value proportional to the magnitude of a heating capacity of the heating member.

3. A fixing apparatus according to claim 1, further comprising a pressure applying member configured to, while being set in pressure contact with the heating member, convey a paper sheet for fixing in a manner to sandwich the paper sheet relative to the heating member.

4. A fixing apparatus comprising:
a heating member;
a coil for induction heating which is positioned near the heating member;
a resonance circuit including the coil as a constituent element;
a switching element configured to excite the resonance circuit;
an oscillator configured to output an ON-OFF signal for ON-OFF driving of the switching element;
a temperature sensor configured to detect the temperature of the heating member;
a detection section configured to detect an amount of variation per unit time of the temperature detected by the temperature sensor; and
an output control section configured to increase or decrease the duty of an ON-OFF signal outputted from the oscillator by a value corresponding to a result of detection by the detection section, while holding the detected temperature of the temperature sensor within an initially set range.

5. A fixing apparatus according to claim 4, wherein said unit time is a value proportional to the magnitude of a heat capacity of said heating member.

6. A fixing apparatus according to claim 4, further comprising a pressure applying member configured to, while being set in pressure contact with the heating member, convey a paper sheet for fixing in a manner to sandwich the paper sheet relative to the heating member.

7. An image forming apparatus comprising:
a heating member;
a coil configured to apply a magnetic field for induction heating to the heating body;
a temperature sensor configured to detect the temperature of the heating body;
a detection section configured to detect an amount of variation per unit time of the temperature detected by the temperature sensor; and
an output control section configured to increase or decrease the output of the coil by an amount corresponding to a result of detection by the detection section while holding the detected temperature by the temperature sensor within an initially set range.

8. An image forming apparatus according to claim 7, wherein said unit time is a value proportional to the magnitude of a heat capacity of the heating member.

9. An image forming apparatus according to claim 7, further comprising a pressure applying member configured to, while being set in pressure contact with the heating member, convey a paper sheet for fixing in a manner to sandwich the paper sheet relative to the heating member.
